(19) United States
(12) Patent Application Publication
(10) Pub. No.: US 2023/0243527 A1
(43) Pub. Date: Aug. 3, 2023

(54) PROTECTIVE AIR SUPPLY SYSTEM IN A CLEAN ROOM AND A METHOD FOR SUPPLYING PROTECTIVE AIR FLOW

(71) Applicant: HALTON OY, Kausala (FI)

(72) Inventors: Kim HAGSTROEM, Kausala (FI); Ismo GROENVALL, Kouvola (FI)

(21) Appl. No.: 18/001,845

(22) PCT Filed: Jun. 14, 2021
(86) PCT No.: PCT/FI2021/050444

§ 371 Date: Dec. 14, 2022

(30) Foreign Application Priority Data
Jun. 15, 2020 (EP) 20179997.0

(51) Int. Cl. F24F 3/167; F24F 11/65; F24F 11/74; F24F 13/06

(52) U.S. Cl. CPC F24F 3/167; F24F 11/65; F24F 11/74; F24F 13/06

(57) ABSTRACT

A protective air supply system for controlling air supply flows in a clean room comprises a first air supply diffuser and a second air supply diffuser, arranged within a ceiling of the clean room on opposite sides of the clean area and spaced from side walls of the clean room, wherein each supply air diffuser is provided with nozzles configured to diffuse a first air flow having a first air flow volume directed along a ceiling of the clean room and towards the clean area and a second air flow having a second air flow volume directed along the ceiling of the clean room and towards a perimeter of the clean room, and a controller coupled to the air supply diffusers and configured to adjust the first and second air flow volumes and their ratio.

### TECHNICAL FIELD

The present invention relates to protective air flow systems in clean rooms. In particular, the present invention relates to control of a fluid flow pattern within a clean room.

### BACKGROUND

HVAC, i.e. heating, ventilating, and air conditioning, is a technology for indoor environmental comfort. Its goal is to provide thermal comfort and acceptable indoor air quality. HVAC system design is a sub-discipline of mechanical engineering, based on the principles of thermodynamics, fluid mechanics, and heat transfer. Refrigeration is sometimes added to the abbreviation as HVAC&R or HVACR, or ventilating is dropped out as in HACR (such as in the designation of HACR-rated circuit breakers). HVAC is important in indoor design where safe and healthy building conditions are regulated with respect to temperature and humidity, using fresh air from outdoors.

Ventilating (the V in HVAC) is the process of changing or replacing air in any space to provide high indoor air quality, for example to control temperature, replenish oxygen, or remove moisture, odors, smoke, heat, dust, airborne bacteria, and carbon dioxide. Ventilation is used to remove unpleasant smells and excessive moisture, introduce outside air, to keep interior building air circulating, and to prevent stagnation of the interior air. Ventilation includes both the exchange of air to the outside as well as circulation of air within the building. It is one of the most important factors for maintaining acceptable indoor air quality in buildings. Methods for ventilating a building may be divided into mechanical or forced and natural types.

The current applications of air distribution principles for critical environments, such as clean rooms like patient and isolation rooms or other rooms, where patients are treated, are based on a simplified thinking of a zoning principle to be used in most critical (EN standard cleanrooms) environments and a dilution principle to be used in other rooms. In many cases, this thinking has led in practice to an unsatisfactory realization of the airflow pattern within the critical environments. In particular in operating rooms where invasive methods are used to treat patients, the presence of operational personnel as a contaminant source in the proximity of the patient causes special challenges in the prevention of wound contamination. Also, the nursing staff in proximity of the patients are heavily exposed to the air exhaled by the patients. The exhaled air contains microbes, that may cause infections to nurses, as well as remains of the medication which may cause various symptoms or discomfort by smells etc. in a long term.

On the other hand, mixing solutions that are currently used in operating rooms are not based on a throughout thinking, and they can fail to provide truly mixed conditions and certainly lack the prevention of the reverse flow into the most critical areas as well as the ability to control the thermal environment and velocity conditions for occupation. One of the common methods is based on the usage of swirl diffusers in the ceiling, typically located symmetrically within the room. This system has both a risk of allowing contaminated air to enter the wound area from the floor level and no means to control the velocity conditions. A second very common method used in the past is a high wall or ceiling/wall corner supply, which is very sensible to the temperature difference between the supply and the room air. Depending on the operational conditions, it may blow the air past the operating personnel prior to entering the wound area or blow the air directly to the floor, thus bringing all the settled contaminants into the operational area. A third very common system is a parallel flow system, in which the air is supplied into the operating area from two elongated air supply devices that are parallel to the operating theater. Compared to the previously mentioned systems, this system has the advantage of providing air supply to the center of the critical zone. However, the design of such a system is based on the avoidance of excessive velocity within the center without the possibility to adjust the jet or velocity. The design is based only on the distance of the air supply device from the center. Thus, the air supply jet or the jet velocity is not adjustable. The reverse flow from the periphery poses a risk in many clean rooms.

Common to all currently used mixing type systems is that they are not capable of providing a flexible air supply flows for different scenarios in a clean room.

### SUMMARY

The objective of the device/method is to provide a protective air supply system and a method for supplying a protective air flow in a clean room. The object is achieved by the features of the independent claims.

According to a first aspect, the present invention provides a protective air supply system for controlling air supply flows in a clean room, wherein the clean room comprises a clean area subject to contamination. The system comprises a first air supply diffuser and a second air supply diffuser, arranged within a ceiling of the clean room and on opposite sides of the clean area and spaced from side walls of the clean room. Each of the supply air diffusers is configured to diffuse a first air flow, having a first air flow volume A l/s, directed along a ceiling of the clean room and towards the clean area; and a second air flow, having a second air flow volume B l/s, directed along the ceiling of the clean room and towards a perimeter of the clean room. Further, the system comprises a controller coupled to the air supply diffusers, and the controller is configured to adjust the first air flow volume A and the second air flow volume B and their ratio.

The advantage of the system is that the ventilation and the supply air flows may be adjusted in different scenarios having different needs, and to meet the requirements of thermal comfort and the safety of the people in the clean room.

In an embodiment of the system, the combined air flow volume A+B is adjustable from 70 l/s to 200 l/s.

In an embodiment of the system, the controller is configured to adjust the ratio of the first air flow volume A and the second air flow volume B between 100:0 and 0:100.

In an embodiment of the system, the controller is configured to switch between an isolation mode and a normal patient mode.

In an embodiment of the system, in the normal patient mode the second air flow volume B is 0 l/s and the first air flow volume A is more than 0 l/s.

In an embodiment of the system, in the isolation mode the first air flow volume A and the second air flow volume B ratio is 1:1.

In an embodiment of the system, in the isolation mode the first air flow volume A is the same as in normal patient mode and the second air flow volume B is increased.

In an embodiment of the system, in the normal patient mode the combined air flow volume is 70 l/s.

In an embodiment of the system, in the isolation mode the combined air flow volume is 200 l/s.

In an embodiment of the system, each of the supply air diffusers is provided with multiple nozzles.

In an embodiment of the system, at least some of the nozzles are closable.

In an embodiment of the system, the supply air diffusers comprise separate chambers for the air to be diffused as the first air flow and the second air flow.

According to another aspect, a method is provided for providing protective air flow in a clean room, wherein the clean room comprises a clean area subject to contamination, comprising steps of:

having a normal patient mode, wherein

diffusing a first air flows from a first supply air diffuser and a second supply air diffuser, arranged within a ceiling of the clean room and on opposite sides of the clean area, each first air flow being directed along the ceiling and towards the clean area and towards each other, so that the first air flow and the second air flow are arranged to collide inside the clean area so that the combined air flow is directed towards the floor of the clean area and the clean area is flushed with the combined air flow,

initiating an isolation mode, wherein, additionally to the normal patient mode,

diffusing a second air flows from the first supply air diffuser and the second supply air diffuser, each second air flow being directed towards the perimeter of the clean room and in opposite direction than the first air flow from the same supply air diffuser.

In an embodiment of the method, supplying air volume A+B of 70 l/s in the normal patient mode.

In an embodiment of the method, increasing the supply air volume A+B to 200 l/s when the isolation mode is initiated.

In an embodiment of the method, adjusting the ratio of the first air flow volume A and the second air flow volume B between 100:0 and 0:100

It is to be understood that the aspects and embodiments of the invention described above may be used in any combination with each other. Several of the aspects and embodiments may be combined together to form a further embodiment of the invention.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 shows a cross section of a clean room from side when system is in a normal patient mode,

FIG. 2 shows a cross section of a clean room from above when the system is in a normal patient mode,

FIG. 3 shows a cross section of a clean room from side when system is in an isolation mode,

FIG. 4 shows a cross section of a clean room from above when the system is in the isolation mode,

FIG. 5 shows a first air supply diffuser and a second air supply diffuser according to an embodiment,

FIG. 6 shows air supply diffusers arranged in circumferential form, i.e. ring-type air supply diffuser according to an embodiment, and

FIG. 7 shows a cover panel of an air supply diffuser comprising multiple nozzles.

### DETAILED DESCRIPTION

The clean room described herein is meant to be a room where a patient is treated and there may be a source of contaminant present when the room is in use. The source of contaminant may be for example the treated patient or the nursing staff treating the patient. Examples of a clean room are an isolation room, an operating theater, a patient treatment room or a patient room. It should be understood that these are only examples and other kind of clean rooms may also be meant.

The present system is configured to provide a (one) combined controlled airflow field in a clean room that may provide substantially uniform cleanness of the indoor environmental conditions in the entire room. They may transport part of contaminants out of a clean treatment area within the room by a jet momentum. They may prevent backflow of the contaminants into the critical zone from the periphery by a jet momentum adjustment. They may provide the desired air velocity conditions for both contaminant control and thermal comfort for the people in the room. To achieve desired contaminant control and thermal control for the people in the clean room, it is provided a protective air supply system having adjustable air supply flows.

The system comprises a first air supply diffuser and a second air supply diffuser, arranged within a ceiling of the clean room on opposite sides of the clean area and spaced from side walls of the clean room. Each of the supply air diffusers is configured to diffuse a first air flow, having a first air flow volume A l/s, directed along a ceiling of the clean room and towards the clean area and a second air flow, having a second air flow volume B l/s, directed along the ceiling of the clean room and towards a perimeter of the clean room. Further, the system comprises a controller coupled to the air supply diffusers and the controller is configured to adjust the first air flow volume A and the second air flow volume B and their ratio. By controlling the air flow volumes, it is possible to provide different modes for different situations in a clean room, e.g. isolation mode and a normal patient mode which set different requirements for the ventilation.

Supply air temperature may also be adjusted. The supply air temperature may be lower than the room air temperature. The supply air temperature may be for example −3 to −5° C. lower than the room air temperature. The supply air temperature may be adjusted by the controller. The system may comprise a first temperature sensor configured to measure the supply air temperature. The system may comprise a second sensor for measuring the room air temperature. The first and second sensors may be connected to the controller for adjusting the temperature. The controller may be connected to the estate management system to retrieve data of the room air temperature. The supply air temperature may be lower only in the isolation mode and/or it may be lowered when the isolation mode is enabled. However, the supply air temperature may also be lower in the normal patient mode.

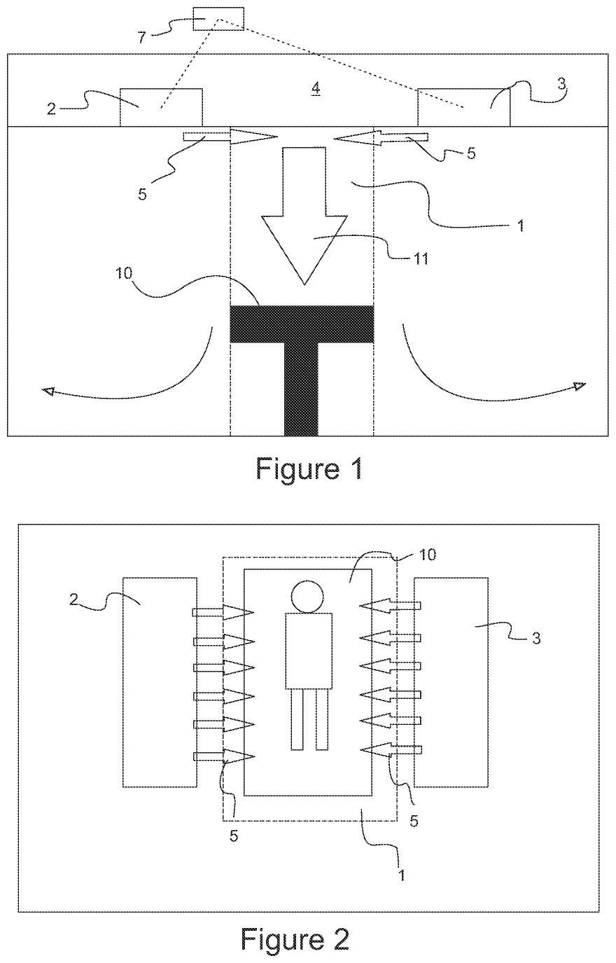

FIGS. 1 and 2 show the operation of the system in a normal patient mode. FIG. 1 shows a cross section of a clean room from side. The clean room comprises a clean area 1, which is typically around an operating area, e.g. patient bed 10. The clean area should be understood as a three-dimensional space from a floor to a ceiling 4 of the clean room.

The system in FIG. 1 comprises a first air supply diffuser 2 and a second air supply diffuser 3 arranged within the ceiling 4 of the clean room. The air supply diffusers 2, 3 are located on opposite sides of the clean area 1, as seen in FIG. 1. The air supply air diffusers may be embedded into the ceiling or they may be installed as a hanging structure so that there is a space between the air supply diffusers and the ceiling. The first air supply diffuser 2 and the second air supply diffuser 3 are located at a distance from side walls of the clean room. In FIG. 1, the first air supply diffuser 2 and the second air supply diffuser is configured to diffuse a first air flows 5, which are directed along the ceiling 4 and towards the clean area 1. The first air flows 5 collides within the clean area and the combined air flow 11 is directed towards the patient bed 10. This combined air flow 11 flushes the clean area 1 towards the floor of the clean room and further towards exhaust outlets in the clean room.

The air supply diffusers may be provided with multiple nozzles through which the air is diffused into the clean room.

FIG. 2 shows the same normal patient mode as FIG. 1, but in view from above. The first air supply diffuser 2 and the second air supply diffuser 3 are located at the opposite sides of the clean area 1 around the patient bed 10. The first air flows 5 are diffused towards the clean area.

In normal patient mode, as shown in FIGS. 1 and 2, the thermal comfort of the patient may be provided in most efficient way. The first air flows 5 are merged and the combined air flow is directed downwards towards the patient bed 10 and the patient. Thus, by adjusting the air flow velocity and the temperature, the thermal comfort of the patient may be easily adjusted. After the combined air flow A+B has reached the patient and the patient be, the combined air flow 11 scatter and the scattered air flows are directed away from the clean area 1 and towards the exhaust air inlets.

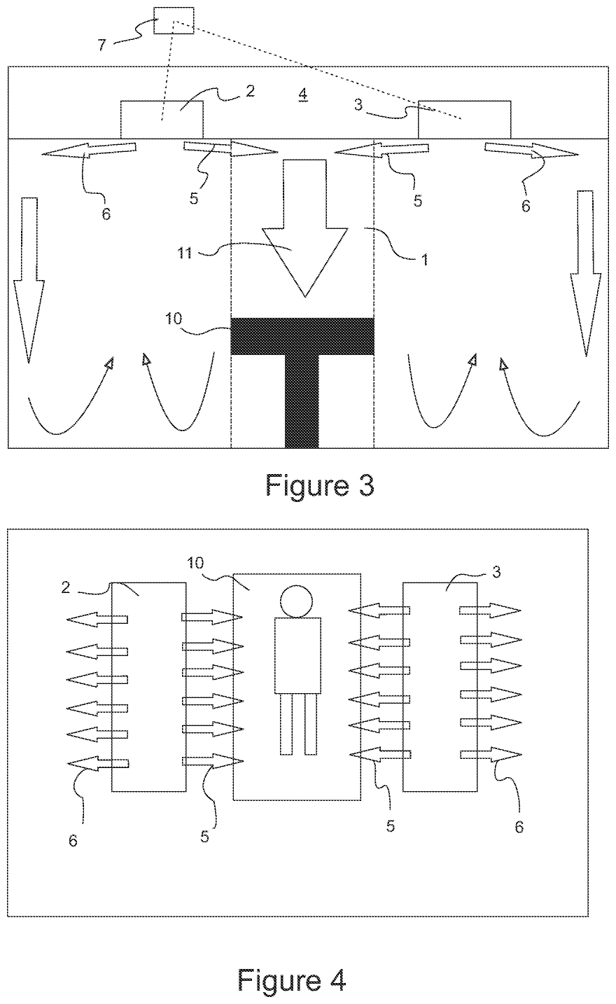

FIGS. 3 and 4 show the operation of the system in an isolation mode comprising all the features of the normal patient mode as described above and additionally more air flow are provided. As seen in FIG. 3, which is a cross section of the clean room like FIG. 1. The first air supply diffuser 2 and the second air supply diffuser 3 are now configured to diffuse a second air flows 6, which are directed along the ceiling 4 and towards the perimeter of the clean room, i.e. towards the side walls. The second air flows 6 are directed in opposite direction than the first air flows 5 in each air supply diffuser 2, 3.

In isolation mode, the first air flows 5 and the combined air flow 10 acts as in normal patient mode. However, the second air flows 6 are directed downwards after they have reached the side walls of the clean room. When the second air flows reach the floor of the clean room, they are directed towards the clean area 1 of the clean room. However, they do not reach the clean area 1 as the scattered air flows from the clean area are directed against the second air flows and they merge before the second air flows reach the clean area 1. The merged air flow is directed upwards outside of the clean area 1.

The air supply volume and the ratio of the first air supply flow 5 and the second air supply flow 6 may be adjusted by a controller 7, which is coupled to the first air supply diffuser 2 and the second air supply diffuser 3. The connection may be wired connection, or it may be wireless connection such as WIFI, Bluetooth or connection using radio frequencies.

The controller 7 has a central role in the operation of the system. Structurally and functionally it may be based on one or more processors configured to execute machine-readable instructions stored in one or more memories that may comprise at least one of built-in memories or detachable memories.

The air supply volume, i.e. combined air flow volume A+B, may be for example 0-200 l/s. The air supply volume may be for example 70 l/s in the normal patient mode and/or 200 l/s in the isolation mode.

The controller may be configured to adjust the ratio of the first air flow volume A and the second air supply flow volume B between 100:0 and 0:100. Above was described that in normal patient mode, the second air supply flow may be absent, and all air supply is diffused as the first air supply flows towards the clean area. However, the controller 7 may be configured to adjust the air supply diffusers so that there is also a second air supply flow in the normal patient mode.

The first air flow volume A may be same, e.g. 70 l/s in normal patient mode and in the isolation mode, while the second air flow volume is increased in the isolation mode.

In order to adjust the air supply flow between the first air supply flow A and the second air supply flow B, at least part of the multiple nozzles 8 in the air supply diffusers may closable. For example, in normal patient mode, the outer nozzles may be closed, and in the isolation mode, the outer nozzles are opened.

The air supply diffusers may be divided in separate air chambers for the first air supply flow and the second air supply flow. In normal patient mode, the chamber for the second air supply flow may be closed and supply air is directed only into the chamber for the first air supply flow. The closing may be achieved for example by a flap which is operable by the controller 7.

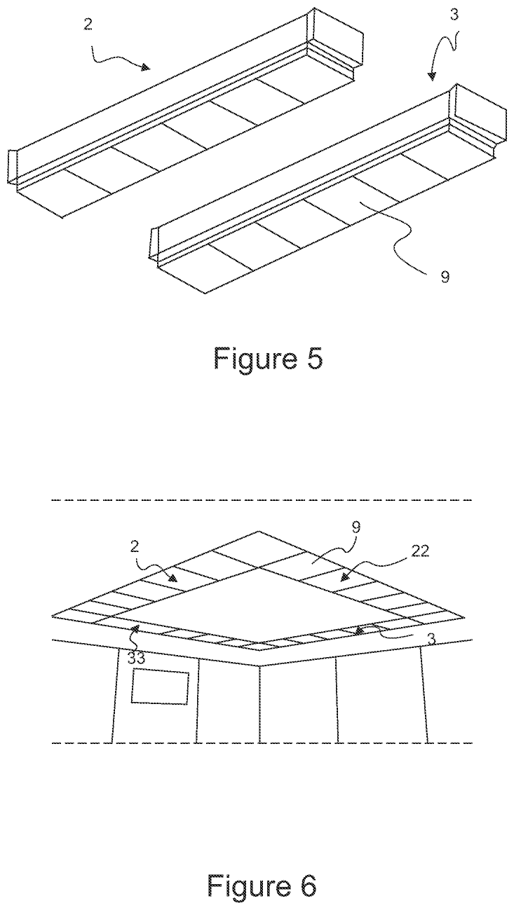

FIG. 5 shows the first air supply diffuser 2 and the second air supply diffuser 3 in assembled state but the ceiling is not shown. The air supply diffuser may comprise cover panel or several cover panels 9 in which the multiple nozzles are arranged. The system may comprise more than two air supply diffusers so that they are provided in different sides of the clean area. The air supply diffusers may be provided in circumferential form so that they are arranged around the clean area as shown in FIG. 6. FIG. 6 shows four air supply diffusers 2, 3, 22 and 33 assembled within the ceiling in circumferential form.

It should be understood that one air supply diffuser may be formed of many smaller air supply diffuser components forming one longer and/or wider air supply diffuser. Further, it should be understood that air supply diffusers may be connected to each other so that they form integrated structure.

The air supply diffusers may be provided within the ceiling so that only cover panel or panels 9 are exposed into the clean room as shown in FIG. 6.

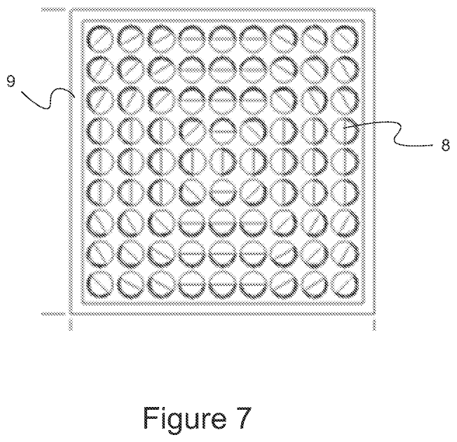

FIG. 7 shows part of the air supply diffuser having multiple nozzles 8. The nozzles are located in a cover panel 9 which is fastened to the air supply diffuser. the form and size of the cover panel may vary. The nozzles may have also different shapes and sizes. The nozzles may be elongated gaps, or they may be circular as shown in FIG. 7. Other forms like rectangular and triangular may also be used. The nozzles may be adjustable so that the air flow diffused through them may be directed in different directions which enable a flexible throw pattern adjustment of the air supply. The front panel 9 may be provided with slotted openings. The nozzles may comprise guiding leaves to adjust the direction of the air supply flow.

Although the invention has been the described in conjunction with a certain type of system, it should be understood that the invention is not limited to any certain type of system. While the present inventions have been described in connection with a number of exemplary embodiments, and implementations, the present inventions are not so limited, but rather cover various modifications, and equivalent arrangements, which fall within the purview of prospective claims.

1. A protective air supply system for controlling air supply flows in a clean room, wherein the clean room comprises a clean area subject to contamination, comprising:
a first air supply diffuser and a second air supply diffuser, arranged within a ceiling of the clean room on opposite sides of the clean area and spaced from side walls of the clean room, wherein each of the first and second air supply diffusers is configured to diffuse:
a first air flow, having a first air flow volume A l/s, directed along the ceiling of the clean room and towards the clean area and
a second air flow, having a second air flow volume B l/s, directed along the ceiling of the clean room and towards a perimeter of the clean room, and
a controller coupled to the first and second air supply diffusers,
wherein the controller is configured to adjust the first air flow volume A l/s and the second air flow volume B l/s and their ratio.

2. The protective air supply system according to claim 1, wherein a combined air flow volume A+B is adjustable from 70 l/s to 200 l/s.

3. The protective air supply system according to claim 1, wherein the controller is configured to adjust the ratio of the first air flow volume A and the second air flow volume B between 100:0 and 0:100.

4. The protective air supply system according to any of previous claim 1, wherein the controller is configured to switch between an isolation mode and a normal patient mode.

5. The protective air supply system according to claim 4, wherein in the normal patient mode the second air flow volume B is 0 l/s and the first air flow volume A is more than 0 l/s.

6. The protective air supply system according to claim 5, wherein in the isolation mode the first air flow volume A and the second air flow volume B ratio is 1:1.

7. The protective air supply system according to claim 5, wherein in the isolation mode the first air flow volume A is the same as in the normal patient mode and the second air flow volume B is increased.

8. The protective air supply system according to claim 4, wherein in the normal patient mode a combined air flow volume A+B is 70 l/s.

9. The protective air supply system according to claim 8, wherein in the isolation mode a combined air flow volume A+B is 200 l/s.

10. The protective air supply system according to claim 1, wherein each of the first and second air supply diffusers is provided with multiple nozzles.

11. The protective air supply system according to claim 10, wherein at least some of the nozzles are closable.

12. The protective air supply system according to claim 1, wherein the first and second air supply diffusers comprise separate chambers for the air to be diffused as the first air flow and the second air flow.

13. A method for providing protective air flow in a clean room, wherein the clean room comprises a clean area subject to contamination, comprising steps of:
having a normal patient mode,
diffusing first air flows and second air flows from a first supply air diffuser and a second supply air diffuser, arranged within a ceiling of the clean room and on opposite sides of the clean area, each first air flow being directed along the ceiling and towards the clean area and towards each other, so that the first air flow and the second air flow are arranged to collide inside the clean area so that a combined air flow is directed towards the floor of the clean area (1) and the clean area is flushed with the combined air flow; and
initiating an isolation mode, wherein, additionally to the normal patient mode,
each second air flow being directed towards the perimeter of the clean room and in an opposite direction than the first air flow from the same supply air diffuser.

14. The method for providing protective air flow in a clean room according to claim 13, further comprising supplying air volume A+B of 70 l/s in the normal patient mode.

15. The method for providing protective air flow in a clean room according to claim 14, further comprising increasing the supply air volume A+B to 200 l/s when the isolation mode is initiated.

16. The method for providing protective air flow in a clean room according to claim 13, wherein adjusting a ratio of a first air flow volume A and a second air flow volume B between 100:0 and 0:100.
